(19) United States
(12) Patent Application Publication
(10) Pub. No.: US 2018/0106883 A1
(43) Pub. Date: Apr. 19, 2018

(54) SENSOR POD

(71) Applicant: Dura Operating, LLC, Auburn Hills, MI (US)

(72) Inventor: Cumhur Unveren, Commerce Twp, MI (US)

(21) Appl. No.: 15/295,360

(22) Filed: Oct. 17, 2016

(51) Int. Cl. G01S 7/03; G01S 13/93

(52) U.S. Cl. CPC G01S 7/032; G01S 2007/027; G01S 13/93

(57) ABSTRACT

A sensor pod includes a main bracket including a base portion, a center support surface spaced apart from the base portion, and first, second, third, and fourth support surfaces connected to the center support surface. Each of the first, second, third, and fourth support surfaces are angled with respect to the center support surface and are disposed equidistant about the center support surface. The first and second support surfaces are connected to the base portion. A center sensor is disposed on the center support surface and first, second, third, and fourth sensors are each one disposed on one of the first, second, third, and fourth support surfaces. A housing is disposed overtop the main bracket, the center sensor, and the first, second, third, and fourth sensors.

### FIELD

The invention relates generally to a sensor pod for a vehicle, and more particularly to a sensor pod for a vehicle having hemi-spherical sensor coverage.

### BACKGROUND

The statements in this section merely provide background information related to the present disclosure and may or may not constitute prior art.

Vehicles, including helicopters, planes, automobiles, heavy trucks, agricultural equipment, railway cars, marine vessels, military hardware, etc., increasingly are being equipped with advanced control technology. This advanced control technology is aimed at improving the safety, efficiency, and performance of the vehicle. Examples of such technologies include advanced driver and flight assistance systems, aeronautical and marine autopilot systems, and collision warning systems, to name but a few. Generally, these advanced control technologies automate, adapt, or enhance vehicle systems in order to increase the vehicle safety, efficiency, and performance.

The addition of these advanced technologies to the vehicle in turn requires a range of additional hardware to implement these systems. For example, many of these advanced control technologies require sensors to be mounted to the vehicle. Thus, there is a constant challenge in packaging and designing these sensors efficiently while not degrading the aerodynamics, fuel efficiency, cost, structural integrity, complexity, and/or appearance of the vehicle.

### SUMMARY

According to several aspects of the present disclosure, a sensor pod is provided. The sensor pod includes a main bracket including a base portion, a center support surface spaced apart from the base portion, and first, second, third, and fourth support surfaces connected to the center support surface. Each of the first, second, third, and fourth support surfaces are angled with respect to the center support surface and are disposed equidistant about the center support surface. The first and second support surfaces are connected to the base portion. A center sensor is disposed on the center support surface and first, second, third, and fourth sensors are each one disposed on one of the first, second, third, and fourth support surfaces. A housing is disposed overtop the main bracket, the center sensor, and the first, second, third, and fourth sensors.

In one aspect, the first, second, third, and fourth support surfaces are angled with respect to the center surface at approximately 45 degrees.

In another aspect, the center sensor and the first, second, third, and fourth sensors are cocoon single chip radar sensors.

In another aspect, the center sensor is a long-range radar sensor and the first, second, third, and fourth sensors are cocoon short-range radar sensors having a shorter range than the long-range radar sensor.

In another aspect, first, second, third, fourth, and fifth cameras are each one disposed on one of the center, first, second, third, and fourth support surfaces.

In another aspect, the sensor pod includes a base plate having a circumferential rim, and the housing contacts the circumferential rim of the base plate.

In another aspect, the base plate includes a central aperture for receiving a wire harness there through, wherein the wire harness is connected to the center, first, second, third, and fourth sensors.

According to several other aspects, a sensor pod for attachment to an outer surface of a vehicle is provided having a base plate configured to be attached to the outer surface of the vehicle, a main bracket having a base portion, a center support surface disposed spaced apart from the base, and support arms extending from the center support surface to the base portion, the support arms disposed equidistant about a periphery of the center support, a center sensor disposed on the center support surface, first, second, third, and fourth sensors each one disposed on one of the support arms, and a partially transparent housing disposed overtop the main bracket, the center sensor, and the first, second, third, and fourth sensors. The center sensor and the first, second, third, and fourth sensors provide complete hemispherical sensor coverage about the sensor pod.

In one aspect, the center support surface is parallel to the base portion and coaxial with the base plate.

In another aspect, the support arms are angled with respect to the center surface at approximately 45 degrees.

In another aspect, the partially transparent housing is vacuum sealed to the base plate.

In another aspect, the center sensor and the first, second, third, and fourth sensors are cocoon single chip radar sensors that provide a hemi-spherical field of radar coverage.

In another aspect, the center sensor is a long-range radar sensor and the first, second, third, and fourth sensors are cocoon radar sensors having a shorter range than the long-range radar sensor.

In another aspect, the sensor pod includes first, second, third, fourth, and fifth cameras each one disposed on one of the center support surface and the support arms that provide a hemi-spherical field of view.

In another aspect, the center sensor, first sensor, second sensor, third sensor, and fourth sensors each include connected circuit boards.

In another aspect, the base plate includes a central aperture for receiving a wire harness there through, wherein the wire harness is connected to the center, first, second, third, and fourth sensors.

In another aspect, the center support and the first second, third, and fourth support arms include fasteners for securing the center sensor, first sensor, second sensor, third sensor, and fourth sensor to the main bracket.

In another aspect, a ring seal is disposed between the base plate and the outer surface of the vehicle.

According to several other aspects, a sensor pod for attachment to an outer surface of a helicopter is provided. The sensor pod includes a base plate configured to be attached to the outer surface of the helicopter, a main bracket having a base portion, a center support surface disposed parallel to the base, and support arms extending from the center support surface to the base portion, the support arms disposed equidistant about a periphery of the center support, a center radar sensor disposed on the center support surface, first, second, third, and fourth radar sensors each one disposed on one of the support arms, a center camera disposed on the center support surface adjacent the center radar sensor, first, second, third, and fourth cameras, each one disposed on one of the support arms adjacent the first second, third, and fourth radar sensors, and at least a partially transparent housing disposed overtop the main bracket and connected to the base plate. The center radar sensor and the first, second, third, and fourth radar sensors provide hemi-spherical radar coverage about the sensor pod and the center camera and the first, second, third, and fourth cameras provide hemi-spherical visual coverage about the sensor pod.

Further aspects, examples, and advantages will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a side view of a vehicle having sensor pods according to aspects of the present disclosure;

FIG. 2 is a top, perspective view of a sensor pod according to aspects of the present disclosure;

FIG. 3 is a cross sectional side elevational view of the sensor pod viewed in the direction of arrow 3-3 in FIG. 2;

FIG. 4 is an exploded perspective view of the sensor pod; and

FIG. 5 is a top view of a mounting bracket and sensor package in the sensor pod according to aspects of the present disclosure.

### DETAILED DESCRIPTION

The following description is merely exemplary in nature and is not intended to limit the present disclosure, application, or uses.

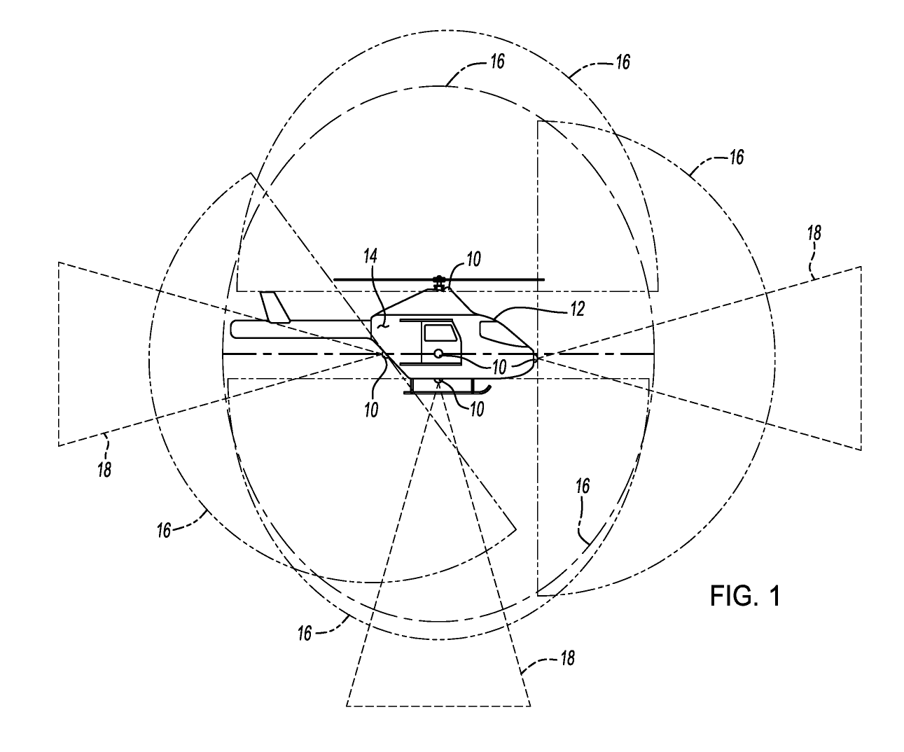

With reference to FIG. 1, sensor pods 10 according to aspects of the present disclosure are shown illustrated on an exemplary vehicle 12. The vehicle 12 is illustrated as a helicopter, however, the vehicle 12 may be a plane, automobile, heavy truck, agricultural or construction vehicle, railway car, marine vessel, or any other type of vehicle without departing from the scope of the present disclosure. The sensor pods 10 are mounted to an exterior surface 14 of the vehicle 12. Generally, the sensor pods 10 are configured to sense or detect objects or visual data. In the example provided, the vehicle 12 includes six sensor pods 10, one each mounted to a front, rear, right side, left side (not shown), top, and bottom of the vehicle 12. Each sensor pod 10 includes a first sensor field of coverage, or short range sensor arc 16. The short range sensor arc 16 for each sensor pod 10 is a substantially hemi-spherical volume emanating from the sensor pod 10. Additionally, the sensor pod 10 may have a second sensor field of coverage, or long range sensor arc 18. The long range sensor arc 18 extends farther than the short range sensor arc 16 and may be cone shaped. Where the vehicle 12 is a helicopter, it is preferable that the sensor pods 10 located on the rear, front, and bottom of the helicopter include long range sensor arcs 18.

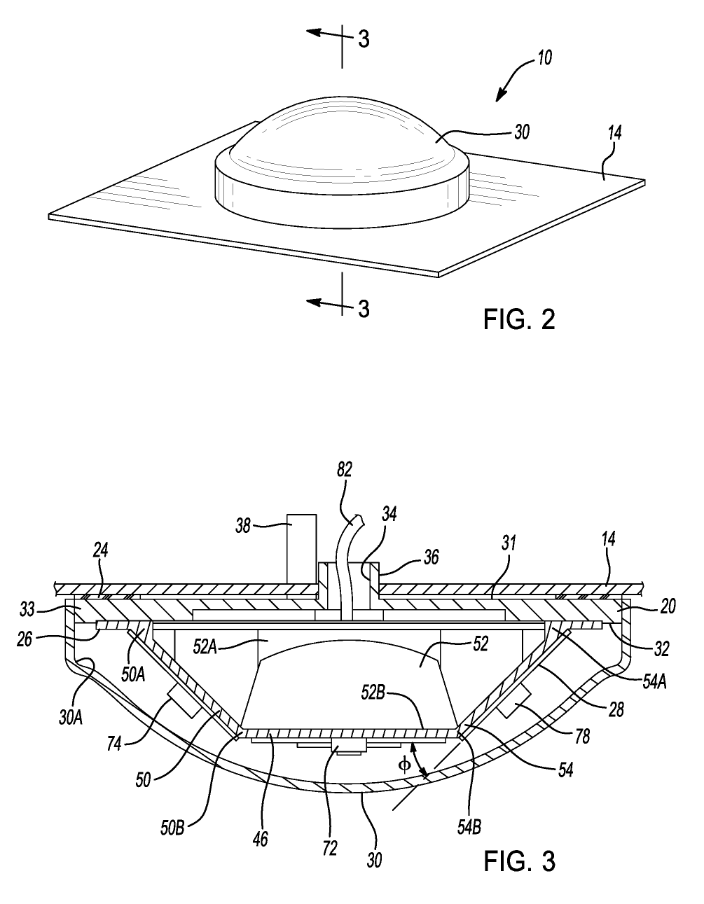

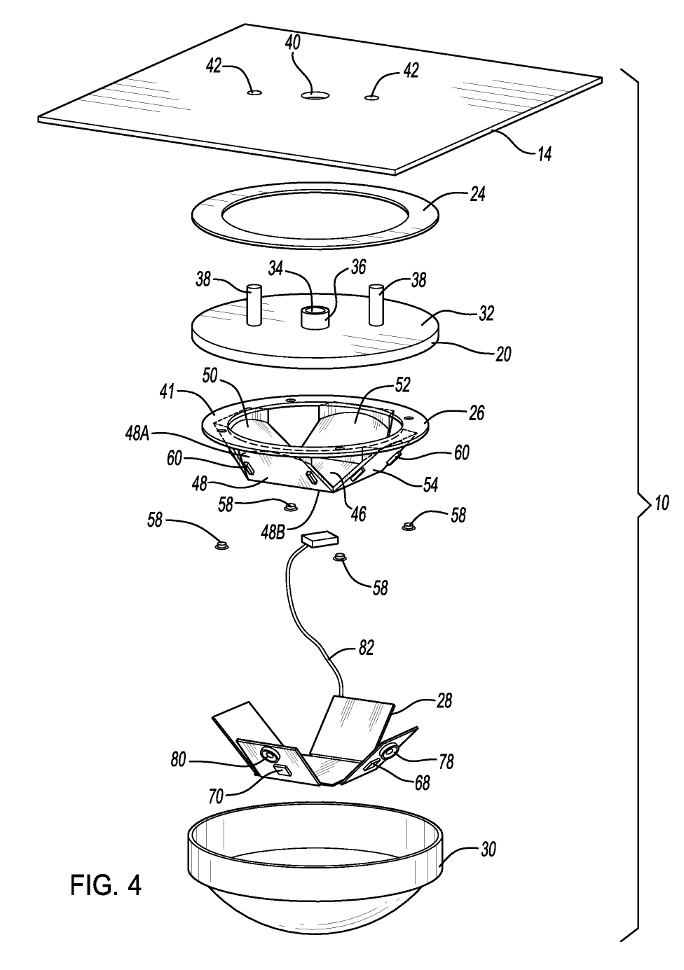

Turning to FIGS. 2-4, the sensor pod 10 is shown mounted to the surface 14 of the vehicle 12. The sensor pod 10 generally includes a base plate 20, a seal member 24, a mounting bracket 26, a sensor package 28, and a housing 30.

The base plate 20 is generally planar and circular and includes an inner surface 31, an outer surface 32, and a circumferential rim 33. The base plate 20 is configured to be secured to the outer surface 14 of the vehicle 12. The base plate 20 functions as a backing or rear housing to the sensor pod 10. The seal member 24 is disposed between the base plate 20 and the outer surface 14 to seal the base plate 20 to the outer surface 14. A center aperture 34 is disposed in the base plate 20 and extends from the inner surface 31 to the outer surface 32. An annular member 36 is disposed around the center aperture 34 on the outer surface 32. A plurality of posts 38 extend out from the outer surface 32. The annular member 36 is sized to fit within a conduit hole 40 formed in the outer surface 14 of the vehicle 12. Likewise, the posts 38 are sized to fit within post holes 42 formed in the outer surface 14 of the vehicle 12.

The mounting bracket 24 is configured to support the sensor package 26 within the sensor pod 10. The mounting bracket 24 includes a base portion 44, a center support 46, a first support arm 48, a second support arm 50, a third support arm 52, and a fourth support arm 54. The base portion 44 has a generally planar ring shape and is configured to be secured to the inner surface 31 of the base plate 20 via fasteners 58. The center support 46 is disposed spaced apart from, and parallel to, the base portion 44 by the first, second, third, and fourth support arms 48, 50, 52, 54. The center support 46 is preferably centrally aligned with the center aperture 34 of the base plate 20 and coaxial therewith.

Each support arm 48, 50, 52, 54 is connected at a thickened end 48A, 50A, 52A, 54A thereof to the base portion 44, respectively. Each support arm 48, 50, 52, 54 is also connected at an opposite end 48B, 50B, 52B, 54B to the center support 46. The support arms 48, 50, 52, 54 are disposed equidistant around the center support 46. Each support arm 48, 50, 52, 54 includes a support surface 48C, 50C, 52C, 54C, respectively, that faces out away from the base plate 20. Each support arm 48, 50, 52, 54 and support surface 48C, 50C, 52C, 54C is angled with respect to the base portion 44 and center support 46 at an angle ϕ. In one aspect, the angle ϕ is approximately 45 degrees. In one aspect, each support arm 48, 50, 52, 54 includes mounting features 60, such as brackets, for securing the sensor package 28 to the mounting bracket 26.

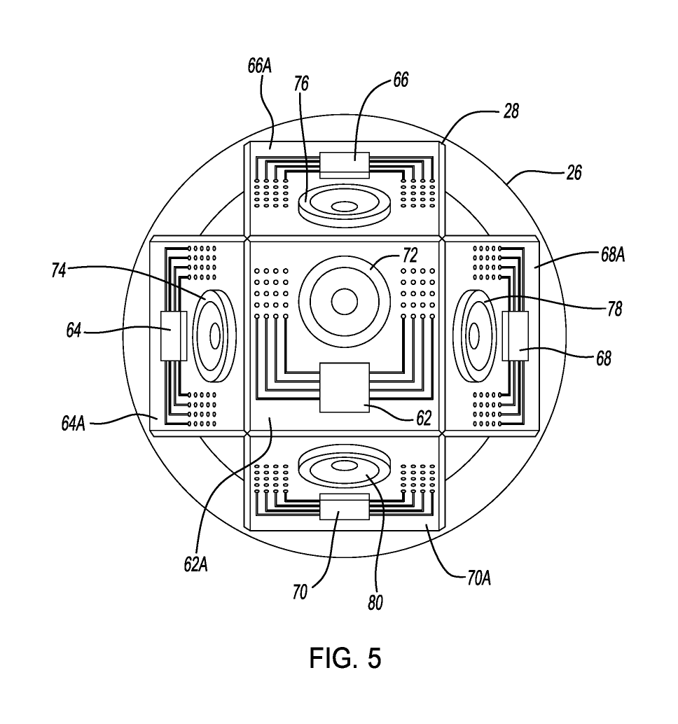

With reference to FIG. 5, and continued reference to FIGS. 2-4, the sensor package 28 generally includes a center sensor 62, a first sensor 64, a second sensor 66, a third sensor 68, and a fourth sensor 70. In one aspect, the sensors 62, 64, 66, 68, 70 are cocoon radar sensors having a single chip radar transceiver mounted to connected circuit boards 62A, 64A, 66A, 68A, 70A, respectively. The center sensor 62 is mounted to the center support 46, the first sensor 64 is mounted to the first support surface 48C, the second sensor 66 is mounted to the second support surface 50C, the third sensor 58 is mounted to the third support surface 52C, and the fourth sensor 70 is mounted to the fourth support surface 54C. Thus, each of the sensors 64, 66, 68, 70 are angled with respect to, and disposed around the periphery of, the center sensor 62. This arrangement of the sensors 62, 64, 66, 68, 70 creates a sensor coverage area for each sensor pod 10 in the hemi-spherical volume 16 illustrated in FIG. 1. In another aspect, the center sensor 62 is a radar transceiver having a longer range than the sensors 64, 66, 68, 70 which creates a sensor coverage area 18 illustrated in FIG. 1.

In another aspect, the sensor package 28 includes a center camera 72, a first camera 74, a second camera 76, a third camera 78, and a fourth camera 80. The center camera 72 is mounted to the center circuit board 62A adjacent the center sensor 62. The first camera 74 is mounted to the first circuit board 64A adjacent the first sensor 64. The second camera 76 is mounted to the second circuit board 66A adjacent the second sensor 66. The third camera 78 is mounted to the third circuit board 68A adjacent the third sensor 68. The fourth camera 80 is mounted to the fourth circuit board 70A adjacent the fourth sensor 70. Thus, the cameras 72, 74, 76, 78, 80 provide a hemi-spherical field of view relative to the sensor pod 10.

In one aspect, the sensors 62, 64, 66, 68, 70 and cameras 72, 74, 76, 78, 80 are connected to a wire harness 82 that extends through the center aperture of the base plate 22 and into the vehicle 12 to connect with a BUS network, LAN, or other electronic system or controller (not shown) in the vehicle 12.

Returning to FIGS. 2-4, the housing 30 is connected to the base plate 20 and encloses and protects the sensor package 28 from the environment. In one aspect, an inner surface 30A of the housing 30 contacts the circumferential rim 33 of the base plate 20. In another aspect, the housing 30 is shaped as a dome and has an aerodynamic shape to reduce air drag on the sensor pod 10. In yet another aspect, the housing 30 is completely transparent. In still yet another aspect, the housing 30 may be partially transparent with opaque sections and transparent windows that align with the cameras 72, 74, 76, 78, 80. In certain aspects, for example where the sensor pod 10 may be used in low atmospheric pressure such as on a helicopter or plane, the housing 30 is vacuum sealed to the base plate 20.

The description of the invention is merely exemplary in nature and variations that do not depart from the gist of the invention are intended to be within the scope of the invention. Such variations are not to be regarded as a departure from the spirit and scope of the invention.

The following is claimed:

1. A sensor pod comprising:
a main bracket including:
a base portion;
a center support surface spaced apart from the base portion; and
first, second, third, and fourth support surfaces connected to the center support surface, wherein each of the first, second, third, and fourth support surfaces are angled with respect to the center support surface and are disposed equidistant about the center support surface, and wherein the first and second support surfaces are connected to the base portion;
a center sensor disposed on the center support surface;
first, second, third, and fourth sensors each one disposed on one of the first, second, third, and fourth support surfaces; and
a housing disposed overtop the main bracket, the center sensor, and the first, second, third, and fourth sensors.

2. The sensor pod of claim 1 wherein the first, second, third, and fourth support surfaces are angled with respect to the center surface at approximately 45 degrees.

3. The sensor pod of claim 1 wherein the center sensor and the first, second, third, and fourth sensors are cocoon single chip radar sensors.

4. The sensor pod of claim 1 wherein the center sensor is a long-range radar sensor and the first, second, third, and fourth sensors are cocoon short-range radar sensors having a shorter range than the long-range radar sensor.

5. The sensor pod of claim 1 further comprising first, second, third, fourth, and fifth cameras each one disposed on one of the center, first, second, third, and fourth support surfaces.

6. The sensor pod of claim 1 further comprising a base plate having a circumferential rim, and wherein the housing contacts the circumferential rim of the base plate.

7. The sensor pod of claim 6 wherein the base plate includes a central aperture for receiving a wire harness there through, wherein the wire harness is connected to the center, first, second, third, and fourth sensors.

8. A sensor pod for attachment to an outer surface of a vehicle, the sensor pod comprising:
a base plate configured to be attached to the outer surface of the vehicle;
a main bracket having a base portion, a center support surface disposed spaced apart from the base, and support arms extending from the center support surface to the base portion, the support arms disposed equidistant about a periphery of the center support;
a center sensor disposed on the center support surface;
first, second, third, and fourth sensors each one disposed on one of the support arms; and
a partially transparent housing disposed overtop the main bracket, the center sensor, and the first, second, third, and fourth sensors, and
wherein the center sensor and the first, second, third, and fourth sensors provide hemi-spherical sensor coverage about the sensor pod.

9. The sensor pod of claim 8 wherein the center support surface is parallel to the base portion and coaxial with the base plate.

10. The sensor pod of claim 8 wherein the support arms are angled with respect to the center surface at approximately 45 degrees.

11. The sensor pod of claim 8 wherein the partially transparent housing is vacuum sealed to the base plate.

12. The sensor pod of claim 8 wherein the center sensor and the first, second, third, and fourth sensors are cocoon single chip radar sensors that provide a hemi-spherical field of radar coverage.

13. The sensor pod of claim 8 wherein the center sensor is a long-range radar sensor and the first, second, third, and fourth sensors are cocoon radar sensors having a shorter range than the long-range radar sensor.

14. The sensor pod of claim 8 further comprising first, second, third, fourth, and fifth cameras each one disposed on one of the center support surface and the support arms that provide a hemi-spherical field of view.

15. The sensor pod of claim 8 wherein the center sensor, first sensor, second sensor, third sensor, and fourth sensors each include connected circuit boards.

16. The sensor pod of claim 8 wherein the base plate includes a central aperture for receiving a wire harness there through, wherein the wire harness is connected to the center, first, second, third, and fourth sensors.

17. The sensor pod of claim 8 wherein the center support and the first second, third, and fourth support arms include fasteners for securing the center sensor, first sensor, second sensor, third sensor, and fourth sensor to the main bracket.

18. The sensor pod of claim 8 wherein the base plate includes a circumferential rim, and wherein the housing contacts the circumferential rim of the base plate.

19. The sensor pod of claim 8 further comprising a ring seal disposed between the base plate and the outer surface of the vehicle.

20. A sensor pod for attachment to an outer surface of a helicopter, the sensor pod comprising:
a base plate configured to be attached to the outer surface of the helicopter;
a main bracket having a base portion, a center support surface disposed parallel to the base, and support arms extending from the center support surface to the base portion, the support arms disposed equidistant about a periphery of the center support;
a center radar sensor disposed on the center support surface;
first, second, third, and fourth radar sensors each one disposed on one of the support arms;
a center camera disposed on the center support surface adjacent the center radar sensor;
first, second, third, and fourth cameras, each one disposed on one of the support arms adjacent the first second, third, and fourth radar sensors; and
at least a partially transparent housing disposed overtop the main bracket and vacuum sealed to the base plate, and
wherein the center radar sensor and the first, second, third, and fourth radar sensors provide hemi-spherical radar coverage about the sensor pod and the center camera and the first, second, third, and fourth cameras provide hemi-spherical visual coverage about the sensor pod.
